(19) United States
(12) Patent Application Publication
(10) Pub. No.: US 2004/0222185 A1
(43) Pub. Date: Nov. 11, 2004

(54) Method of dry-etching a multi-layer film material

(75) Inventor: Kenji Kawai, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/693,982

(22) Filed: Oct. 28, 2003

(30) Foreign Application Priority Data
May 7, 2003 (JP) 2003-129284(P)

(51) Int. Cl. B44C 1/22

(52) U.S. Cl. 216/22

(57) ABSTRACT

A method of dry-etching a multi-layer film material including a thin metal film is provided, wherein a combination of at least one of gases including a gas containing a carbonyl group and a gas containing a halogen element, and an electron donating gas is used as an etching gas. With the method, a method of dry-etching a multi-layer film material is provided, wherein the etching characteristic such as the etching rate, etching anisotropy and the like can be improved, and a formed polymer film at a sidewall of a pattern can not only be reduced but removed efficiently.

### BACKGROUND OF THE INVENTION

1. Field of the Invention

The present invention relates to a method of dry-etching a multi-layer film material including a thin metal film. More particularly, the present invention relates to a method of dry-etching accurately and efficiently a multi-layer film material including a thin metal film, which is useful for manufacturing an integrated magnetic memory such as a magnetic random access memory (MRAM) or a magnetic head.

2. Description of the Background Art

Conventionally, for a method of etching a multi-layer film material of a thin metal film such as an NiFe film, a CoFe film or the like identified as a magnetic film, physical sputter etching by ion milling has mainly been employed. Some reasons are as follows: the etching by ion milling can be applied to any material to be etched. It also allows desirable anisotropic processing in a perpendicular direction. Additionally, with an ion beam provided in a tilted manner, a shape to be etched can be controlled to a certain degree. Still additionally, as it does not use a reactive gas, it is safe and requires no equipment for treating an emitted gas.

However, reflecting the demand for higher recording density in recent years, there are increased needs of further microfabrication, less damage to a multi-layer film material in etching, improved selectivity of a multi-layer film material with respect to a masking material in etching. Consequently, replacement with plasma-etching is earnestly required.

However, some problems occur in performing plasma-etching on a magnetic film. For example, since an appropriate etching gas to form a volatile reaction product has not yet been found, a reaction product caused by etching adheres to a sidewall of an etched material, leading to a tapered sidewall. As a result, it is difficult to achieve desirable anisotropic processing in a perpendicular direction. Additionally, since an appropriate rinsing solution to remove a polymer film adhered to a sidewall of an etched material has not yet been found, leakage current occurs between upper and lower magnetic films to degrade the material characteristic.

Recently, the following have been proposed for a method of dry-etching a nonvolatile magnetic film such as an NiFe film, a CoFe film or the like.

One is a method of dry-etching an NiFe alloy or an NiFeCo alloy using at least one of or a combination of gases including Cl₂, BCl₃, Ar, and O₂ (Japanese Patent Laying-Open Nos. 2001-110663 and 2002-30470).

Another is a method of dry-etching a magnetic yoke film using at least one of gases including F₂, C₁₂, Br₂, I₂, CO, and BCl₃ (Japanese Patent Laying-Open No. 2002-230720). This is a method of promoting etching by using a mixed gas of a CO gas and a halogen gas (such as a Cl₂ gas) as an etching gas to form and volatize a metal carbonyl compound and a metal halogenide.

In the methods of dry-etching described in Japanese Patent Laying-Open Nos. 2001-110663 and 2002-30470, however, since a halogen gas is mainly used as an etching gas, a metal halogenide formed by etching is less likely to volatize and adheres to a sidewall of an etched material. As it is difficult to be removed, a special removing step is required.

In the method of dry-ethcing described in Japanese Patent Laying-Open No. 2002-230720, a CO gas is used. Therefore, a metal carbonyl compound formed by etching is more volatile than the metal halogenide described above. However, the CO gas is unstable itself, easily causing a reaction from which C and CO₂ are produced. Consequently, there is a case where a metal-CO bond is not formed, or, if formed, the metal-CO bond is unstable and easily decomposes, resulting in re-adherence to the etched body.

In other words, in a conventional etching method using as an etching gas a CO gas, a halogen gas or the like, a metal carbonyl compound or a metal halogenide formed by dry-etching adheres as a polymer film to a sidewall of an etched pattern of an etched material. Since such a polymer film at the sidewall of the pattern is difficult to remove, the etching rate is disadvantageously decreased. Additionally, since the sidewall of the pattern is tapered, etching with desirable anisotropic processing in a perpendicular direction is difficult to achieve.

### SUMMARY OF THE INVENTION

An object of the present invention is to provide a method of dry-etching a multi-layer film material, wherein the etching characteristic such as the etching rate, etching anisotropy and the like can be improved, and wherein a formed polymer film at a sidewall of a pattern can not only be reduced but removed efficiently.

In order to achieve the object described above, a method of dry-etching a multi-layer film material in accordance with an aspect of the present invention is a method of dry-etching a multi-layer film material including a thin metal film, wherein a combination of at least one of gases including a gas containing a carbonyl group and a gas containing a halogen element, and an electron donating gas is used as an etching gas.

A method of dry-etching a multi-layer film material in accordance with another aspect of the present invention is a method of dry-etching a multi-layer film material including a thin metal film, wherein a combination of at least one of gases including a gas containing a halogen element, an inert gas, an oxygen gas, and an ozone gas, a gas containing a carbonyl group, and an electron donating gas is used as an etching gas.

In accordance with the present invention, in dry-etching the thin metal film material, since the combination of at least one of gases including the gas containing a carbonyl group and the gas containing a halogen element, and the electron donating gas is used as an etching gas, the present invention can improve the etching characteristic such as the etching rate, etching anisotropy and the like, and reduce formation of a polymer film at a sidewall of a pattern.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1D illustrate a method of dry-etching a multi-layer film material in accordance with the present invention.

FIG. 2 illustrates a method of detecting an endpoint of a reaction of removing a polymer film at a sidewall of a pattern using a rinsing solution in accordance with the present invention.

FIGS. 3A and 3B illustrate a representative method of dry-etching a multi-layer film material.

### DESCRIPTION OF THE PREFERRED EMBODIMENTS

A method of dry-etching a multi-layer film material in accordance with an aspect of the present invention is a method of dry-etching a multi-layer film material including a thin metal film, wherein a combination of at least one of gases including a gas containing a carbonyl group and a gas containing a halogen element, and an electron donating gas is used as an etching gas.

The gas containing a carbonyl group or the gas containing a halogen element reacts with the thin metal film to form a volatile metal carbonyl compound or a volatile metal halogenide for dry-etching the thin metal film. The electron donating gas is added to these gases to promote formation of the metal carbonyl compound or the metal halogenide, allowing an increased etching rate and increased etching anisotropy. Though the mechanism of promoting formation of the metal halogenide is not yet clarified, the mechanism of promoting formation of the metal carbonyl compound may be attributed to an electron donated by the electron donating gas, which serves for stabilizing a metal-carbonyl (CO) bond.

The gas containing a carbonyl group is a gas whose gas compound contains a carbonyl group (CO), examples of which include: CO, CO₂, (NH₂)₂CO (urea), COCl₂ (phosgene), COS (carbonyl sulfide), H₂CO, (CH₃)₂CO and the like. The gas containing a halogen element is a gas whose gas compound contains a halogen element (X), examples of which include: HF, HCl, Cl₂, BCl₃, HBr, BBr₃, HI, HCCl₃ and the like.

The electron donating gas is generally a gas composed of atoms having extremely different electronegativities or ionization potentials, or a gas including an atom with a lone electron pair. Therefore, the electron donating gas tends to provide an electron easily with other compounds. Its examples preferably used in the present invention include: SF₆, PH₃, PF₃, PCl₃, PBr₃, PI₃, CF₄, AsH₃, SbH₃, BiH₃, SO₃, SO₂, H₂S, SeH₂, TeH₂, Cl₃F, H₂O, H₂O₂, phenols, alcohols, polyhydric alcohols, calboxylic acids, ethers, aldehydes, alkyne containing two to five carbon atoms, alkene containing two to five carbon atoms, alkane containing one to five carbon atoms and the like.

Their preferable examples include: phenol, cresol and the like for the phenols; methanol, ethanol and the like for the alcohols; ethylene glycol, glycerin and the like for the polyhydric alcohols; formic acid, acetic acid, benzoic acid and the like for the calboxylic acids; dimethyl ether, methyl ethyl ether and the like for the ethers; formaldehyde, acetaldehyde and the like for the aldehydes; acetylene, methyl acetylene and the like for the alkyne containing two to five carbon atoms; ethylene, propylene and the like for the alkene containing two to five carbon atoms; methane, ethane, propane and the like for the alkane containing one to five carbon atoms.

Along with the gases described above, an inert gas, an oxygen gas, or an ozone gas can be combined as the etching gas. The inert gas is a gas which causes no chemical reaction with a thin metal film. Its examples include: a He gas, an Ar gas, an N₂ gas and the like. The inert gas is effective in increasing the etching rate. The oxygen (O₂) gas or the ozone (O₃) gas tends to selectively etch a Ru-containing metal as well as easily remove a polymer film containing a carbon (C) atom in etching with a resist mask.

Though the composition ratio of respective gases included in the etching gas is not particularly limited, the mole ratio of the electron donating gas to the gas containing a carbonyl group or the gas containing a halogen element is preferably 0.05 to 1. When the gas containing a carbonyl group and the gas containing a halogen element are both used, the mole ratio of the gas containing a carbonyl group to the gas containing a halogen element and the gas containing a carbonyl group is preferably 0.1 to 0.95.

A method of dry-etching a multi-layer film material in accordance with another aspect of the present invention is a method of dry-etching a multi-layer film material including a thin metal film, wherein a combination of at least one of gases including a gas containing a halogen element, an inert gas, an oxygen gas, and an ozone gas, a gas containing a carbonyl group, and an electron donating gas is used as an etching gas.

As described above, the added electron donating gas promotes formation of the metal carbonyl compound or the metal halogenide, allowing an increased etching rate and increased etching anisotrophy. Additionally, for the carbonyl (CO) group where the C atom serving as a part of a functional group has electrophilicity, an effect of stabilizing the metal-CO bond by the electron donating gas is significant. This promotes formation of a volatile metal carbonyl compound to further increase an etching rate. Additionally, with its volatility, an amount of the metal carbonyl compound adhered as a polymer film at a sidewall of a pattern is reduced to further increase etching anisotropy.

The method of dry-etching the multi-layer film material in accordance with the present invention, wherein the multi-layer film material including the thin metal film is a multi-layer film material having a three layer structure of a magnetic layer, a tunnel barrier layer, and another magnetic layer, includes the step of stopping etching at the tunnel barrier layer in dry-etching, wherein at least one of increasing a ratio of flow rate of the gas containing a carbonyl group and decreasing a ratio of flow rate of the gas containing a halogen element can be achieved in the etching gas prior to exposing the tunnel barrier layer.

With the method in accordance with the present invention, etching can effectively be stopped at the tunnel barrier layer. Increasing a ratio of flow rate of the gas containing a carbonyl group can decrease reaction between the etching gas and the tunnel barrier layer to prevent the tunnel barrier layer from peeling off. Decreasing a ratio of flow rate of the gas containing a halogen element can reduce formation of an aluminum halogenide (AlX₃) having a high vapor pressure to increase selectivity to the tunnel barrier layer. Decreasing a ratio of flow rate of the inert gas can also be effective in increasing selectivity to the tunnel barrier layer.

The method of dry-etching the multi-layer film material in accordance with the present invention, wherein the multi-layer film material including the thin metal film is a multi-layer film material having a three layer structure of a magnetic layer, a tunnel barrier layer, and another magnetic layer, includes the step of stopping etching at the tunnel barrier layer in dry-etching, wherein in a latter etching process after the step of stopping etching, a pattern of the magnetic layer formed in a former etching process prior to the step of stopping etching can be covered to be dry-etched.

A condition of dry-etching in accordance with the present invention is conveniently adjustable to any range depending on the composition of the etching gas as long as the object of the present invention is accomplished. Preferably, the dry-etching is performed under a condition where the pressure ranges from 0.2 Pa to 4.0 Pa, the electrical power of the top electrode ranges from 100 W to 1,000 W, the electrical power of the bottom electrode ranges from 20 W to 100 W, and the temperature of the bottom electrode ranges from 0° C. to 50° C.

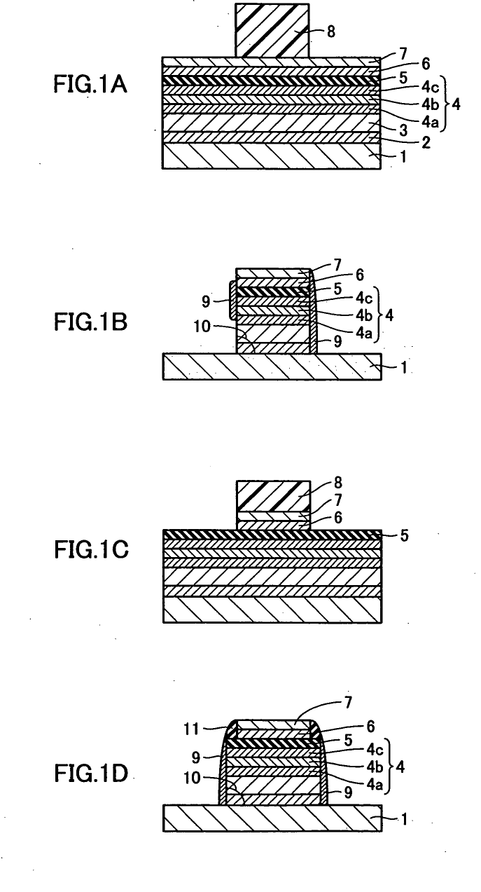

As shown in FIG. 1A, a buffer layer 2, an antiferromagnetic layer 3, a lower ferromagnetic layer 4, a tunnel barrier layer 5, an upper ferromagnetic layer 6, and a cap layer 7 are sequentially deposited on an underlying interconnector 1 to form a semiconductor layer. When an etching mask 8 is provided at the semiconductor layer for dry-etching, a polymer film 9 at a sidewall of a pattern may be formed to connect lower ferromagnetic layer 4 and upper ferromagnetic layer 6. If such polymer film 9 at the sidewall of the pattern cannot be removed completely, a short circuit will occur since polymer film 9 at the sidewall of the pattern contains metal.

In order to solve the problem described above, as shown in FIG. 1C, a step of stopping etching at tunnel barrier layer 5 is provided. As shown in FIG. 1D, a pattern of the magnetic layer formed in a former etching process prior to the step of stopping etching is covered with a side spacer 11 to perform a latter etching process. Though it is not shown, the pattern of the magnetic layer formed in the former etching process may be covered with an etching mask, for example, in place of the side spacer described above to perform the latter etching process. In the step shown in FIG. 1C, after stopping etching at tunnel barrier layer 5 and before forming the side spacer or the etching mask, the polymer film at the sidewall of the pattern formed in the former etching process is preferably removed with a rinsing solution. The tunnel barrier layer is an insulating layer formed between the upper magnetic layer and the lower magnetic layer, examples of which include Al₂O₃ and the like.

Though any type of side spacer can be used, an insulating film such as a silicon nitride film (Si₃N₄), a silicon oxide film (SiO₂), a silicon oxynitride film (SiON) or the like is preferably used in order to ensure insulation between the upper magnetic layer and the lower magnetic layer. After the etched pattern of the upper ferromagnetic layer is formed, the insulating film described above is formed at its entire surface to undergo etching thereon with a gas containing a halogen element, an inert gas or the like to form the side spacer.

The method of dry-etching the multi-layer film material in accordance with the present invention can, in addition to the step of dry-etching described above, further include a step of removing the polymer film at the sidewall of the pattern formed by the step of dry-etching by using a liquid containing at least one selected from the group consisting of sulfuric acid, hydrochloric acid, ammonia, cyanide, and alkylamin, or pure water.

When dry-etching is performed using the etching gas including the gas containing a carbonyl group or the gas containing a halogen element, a metal, or a metal carbonyl compound or a metal chloride formed by a reaction between a metal and the etching gas may be captured and remain in the polymer film at the sidewall of the pattern. Especially when the etching gas includes the gas containing a halogen element, the metal chloride having a high vapor pressure is easily captured and remains in the polymer film at the sidewall of the pattern. The polymer film at the sidewall of the pattern can be removed using the liquid containing sulfuric acid, for example, or pure water to prevent a degraded characteristic such as a short circuit of the multi-layer film material.

The cyanide is a compound containing a CN group such as HCN, NaCN, KCN and the like. The alkylamin includes any of primary amin (R¹—NH₂), secondary amin (R²R³—NH), and tertiary amin (R⁴R⁵R⁶—N) (wherein R¹ to R⁶ represent same or different alkyl groups individually).

For example, the metal chloride of the polymer film at the sidewall of the pattern becomes soluble by reactions described in the following equations (1), (2) and the like, wherein M represents a metallic element:

MClₓ+NH₃→M(NH₃)_{y} (1)

MClₓ+HCN→M(CN)_{y} (2)

In the step of removing the polymer film at the sidewall of the pattern using the solution described above, a change of the rinsing solution or the rinsing solution having been already used in color, electric conductivity, or specific gravity can be used to detect an endpoint of the reaction. With the method of the present invention, the endpoint of the reaction can be easily detected, and the polymer film at the sidewall can sufficiently be removed without damaging the magnetic layer.

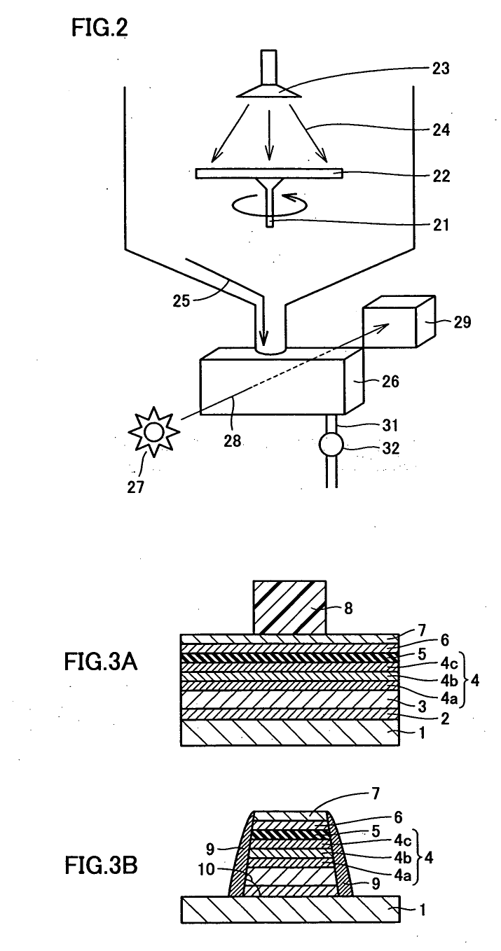

In accordance with FIG. 2, the method of detecting the endpoint of the reaction as described above will be described. For example, a wafer 22 having the polymer film at the sidewall of the pattern is fixed at a suction pin 21. With suction pin 21 rotated, a rinsing solution 24 to remove the polymer film at the sidewall of the pattern is injected to wafer 22 from a nozzle 23 for injecting a rinsing solution. After rinsing the polymer film at the sidewal of the pattern, the rinsing solution having been already used 25 is collected in an analyzer tube 26 to be radiated by light 28 for analysis from a light source 27. A change of rinsing solution 24 or rinsing solution having been already used 25 in color is measured with an analyzer 29 to detect the endpoint of the process of removing the polymer film at the sidewall of the pattern.

For example, when a thin metal film containing Fe is etched with a Cl₂ gas, FeCl₂ is contained in the polymer film at the sidewall of the pattern. Consequently, when the polymer film at the sidewall of the pattern is brought into contact with a rinsing solution containing cyanide such as NaCN, [Fe(CN)₆]⁴ is formed as in the following equation (3) and dissolves easily into the rinsing solution:

FeCl₂+NaCN→[Fe(CN)₆]⁴ (3)

As FeCl₂ is achromatic and [Fe(CN)₆]4 is yellow, a change of the rinsing solution or the rinsing solution having been already used in color can be measured to recognize a change in amount of the removed polymer film at the sidewall of the pattern to detect the endpoint of the process of removing the polymer film at the sidewall of the pattern. If no compound which develops color from a reaction with a metal included in the thin metal film is contained in the rinsing solution, a reagent for a colorimetric quantitative analysis may be used, an example of which is o-phenanthroline that develops reddish orange color from a reaction with Fe (II).

For another method, a change of the rinsing solution or the rinsing solution having been already used in electric conductivity or specific gravity can also be used to detect the endpoint of the reaction.

The present invention will be described more particularly based on examples below.

### FIRST EXAMPLE

As shown in FIG. 1A, buffer layer 2 of NiFe of 2 nm thickness, antiferromagnetic layer 3 of PtMn of 5 nm thickness, lower ferromagnetic layer 4 made of a CoFe layer 4a of 3 nm thickness, a Ru layer 4b of 1 nm thickness, and another CoFe layer 4c of 3 nm thickness, tunnel barrier layer 5 of Al₂O₃ of nm thickness, upper ferromagnetic layer 6 of NiFe of 5 nm thickness, and cap layer 7 of Ta of 10 nm thickness were deposited on underlying interconnector 1 of Cu of 100 nm thickness to form the multi-layer film material. Etching mask 8 was then formed thereat.

For the etching gas, CO as the gas containing a carbonyl group, Cl₂ as the gas containing a halogen element, CH₄ as the electron donating gas, and Ar as the inert gas were selected to form a mixed gas for use containing a CO gas of 20 sccm flow rate, a Cl₂ gas of 10 sccm flow rate, a CH₄ gas of 2 sccm flow rate, and an Ar gas of 100 sccm flow rate. When the etching gas was used to perform dry-etching at 2.0 Pa as a pressure, at 600 W as an electrical power of the top electrode and 60 W as an electrical power of the bottom electrode, and at 25° C. as a temperature of the bottom electrode, an etched pattern as shown in FIG. 1B was obtained. The average etching rate in the step was 30 nm/min, and a taper angle 10 of the sidewall of the pattern was 86°. For explanation, sccm, a unit of a gas flow rate, is an abbreviation of standard cubic centimeter per minute, representing a flow rate per minute in cm³ under a standard condition (1013 hPa, 0° C.).

### FIRST COMPARATIVE EXAMPLE

Referring to FIG. 3A, as in the first example, a step of dry-etching was performed excluding that a mixed gas of CO/Cl₂/Ar was used as an etching gas at respective flow rates of 25 sccm/5 sccm/100 sccm. An etched pattern as shown in FIG. 3B was obtained. The average etching rate in the step was 20 nm/min, and taper angle 10 of the sidewall of the pattern was 75°.

When the first example was compared with the first comparative example, since the electron donating gas was added to the gas containing a carbonyl group and the gas containing a halogen element, the etching rate was increased by a factor of 1.5 and the taper angle of the sidewall of the pattern was increased from 75° to 86°, which is almost a right angle. Additionally, an amount of the polymer film at the sidewall of the pattern was apparently reduced to half.

### SECOND EXAMPLE

A step of dry-etching was initiated on a multi-layer film material having the same structure under the same etching condition as those of the first example (a pressure:2.0 Pa, an electrical power of the top electrode/the bottom electrode: 600 W/60 W, a temperature of the bottom electrode: 25° C.) using an etching gas having the same composition as that of the first example (CO/Cl₂/CH₄/Ar with respective flow rates of 20 sccm/10 sccm/2 sccm/100 sccm). Before the tunnel barrier layer was exposed, flow rates of respective gases in the etching gas were changed: 20 sccm for the CO gas, 5 sccm for the Cl₂ gas, 5 sccm for the CH₄ gas, and 100 sccm for the Ar gas. As shown in FIG. 1C, etching was performed up to upper ferromagnetic layer 6 and stopped at tunnel barrier layer 5. The polymer film at the sidewall of the pattern adhered to the etched pattern of the upper ferromagnetic layer was then rinsed with an aqueous solution containing 60% hydroxylamine (NH₂OH) by mass and 20% aminoethoxy alcohol (NH₂CH₂CH₂OH) by mass.

As shown in FIG. 1D, side spacer 11 made of a silicon nitride film (Si₃N₄) was formed at the sidewall of the pattern of the upper ferromagnetic layer. The step of dry-etching was successively performed under the same etching condition and using an etching gas having the same composition as those of the first example. In this way, the multi-layer film material ensuring insulation between the upper and lower ferromagnetic layers was obtained.

### THIRD EXAMPLE

The multi-layer film material obtained from the step of dry-etching in the first or second example, with the polymer film at the sidewall of a pattern adhered thereto, was rinsed using an aqueous liquid as a rinsing solution containing 60% hydroxylamine by mass, 20% aminoethoxy alcohol by mass, and 1% o-phenanthroline by mass. The 1% o-phenanthroline by mass was added as a reagent for conducting a calorimetric quantitative analysis on Fe (II).

As shown in FIG. 2, the multi-layer film material where the polymer film at the sidewall of the pattern was adhered was fixed at suction pin 21. With suction pin 21 rotated, rinsing solution 24 described above was injected to the multi-layer film material from nozzle 23 for injecting a rinsing solution to rinse the polymer film at the sidewall of the pattern. After rinsing, rinsing solution having been already used 25 was introduced into analyzer tube 26 to conduct a colorimetric quantitative analysis. At the time when coloration of the rinsing solution having been already used drastically decreased, the multi-layer film material was taken out and its surface was observed with an electron microscope. The observation showed that the polymer film at the sidewall of the pattern was completely removed and that the underlying interconnector was undamaged.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of dry-etching a multi-layer film material including a thin metal film, wherein a combination of at least one of gases including a gas containing a carbonyl group and a gas containing a halogen element, and an electron donating gas is used as an etching gas.

2. A method of dry-etching a multi-layer film material including a thin metal film, wherein a combination of at least one of gases including a gas containing a halogen element, an inert gas, an oxygen gas, and an ozone gas, a gas containing a carbonyl group, and an electron donating gas is used as an etching gas.

3. The method of dry-etching the multi-layer film material according to claim 1, wherein the electron donating gas is a gas containing at least one selected from the group consisting of SF₆, PH₃, PF₃, PCl₃, PBr₃, PI₃, CF₄, AsH₃, SbH₃, BiH₃, SO₃, SO₂, H₂S, SeH₂, TeH₂, C₁₃F, H₂O, H₂O₂, phenols, alcohols, polyhydric alcohols, calboxylic acids, ethers, aldehydes, alkyne containing two to five carbon atoms, alkene containing two to five carbon atoms, and alkane containing one to five carbon atoms.

4. The method of dry-etching the multi-layer film material according to claim 1, wherein the multi-layer film material including the thin metal film is a multi-layer film material having a three layer structure of a magnetic layer, a tunnel barrier layer, and another magnetic layer, comprising the step of:
stopping etching at the tunnel barrier layer in dry-etching, wherein at least one of increasing a ratio of flow rate of the gas containing the carbonyl group and decreasing a ratio of flow rate of the gas containing the halogen element is achieved in the etching gas prior to exposing the tunnel barrier layer.

5. The method of dry-etching the multi-layer film material according to claim 1, wherein the multi-layer film material including the thin metal film is a multi-layer film material having a three layer structure of a magnetic layer, a tunnel barrier layer, and another magnetic layer, comprising the step of:
stopping etching at the tunnel barrier layer in dry-etching, wherein in a latter etching process after the step of stopping etching, a pattern of the magnetic layer formed in a former etching process prior to the step of stopping etching is covered to be dry-etched.

6. The method of dry-etching the multi-layer film material according to claim 1, wherein the method further comprises the step of removing a polymer film at a sidewall of a pattern formed by dry-etching by using as a rinsing solution a liquid containing at least one selected from the group consisting of sulfuric acid, hydrochloric acid, ammonia, cyanide, and alkylamin, or pure water.

7. The method of dry-etching the multi-layer film material according to claim 6, wherein in the step of removing the polymer film at the sidewall of the pattern by using the rinsing solution, a change of the rinsing solution or the rinsing solution having been already used in color, electric conductivity, or specific gravity is used to detect an endpoint of a reaction.
